(19) United States
(12) Patent Application Publication
(10) Pub. No.: US 2005/0276888 A1
(43) Pub. Date: Dec. 15, 2005

(54) Methods for maintaining fruit color

(76) Inventors: Yanyun Zhao, Beaverton, OR (US); Dennis C. Anderson, Corualliss, OR (US); Thao Ngo, Corvallis, OR (US)

Correspondence Address: MOAZZAM LATIMER LLP, 1474 NORTH POINT VILLAGE CENTER #320, RESTON, VA, 20194-1190, US

(21) Appl. No.: 11/071,526

(22) Filed: Mar. 4, 2005

Related U.S. Application Data
(60) Provisional application No. 60/550,650, filed on Mar. 5, 2004.

(51) Int. Cl. A23L 1/27

(52) U.S. Cl. 426/262

(57) ABSTRACT

The present invention provides a process for producing green vegetables and fruits having all or substantially all of their green color preserved during processing. In general, the process comprises exposing the vegetables and fruits to zinc to preserve green pigments in the skins, peels, etc. The present invention also provides color-preserved green vegetables and fruits made by the process of the present invention.

### CROSS-REFERENCE TO RELATED APPLICATIONS

This application relies on, and claims the benefit of the filing date of, U.S. provisional patent application No. 60/550,650, filed 5 Mar. 2004, the entire disclosure of which is incorporated herein by reference.

### BACKGROUND OF THE INVENTION

1. Field of the Invention

The present invention relates generally to methods of treating agricultural products. More specifically, it relates to methods of maintaining fruits at a certain desired color during or after processing, and to the fruits and fruit products treated by such methods. The method has particular applicability to thermally processed fruits.

2. Discussion of Related Art

For nutritional and aesthetic reasons, it is desirable to prepare color-stabilized, thermally processed green pears. Thermal processing and packaging pears or pear products into containers (i.e., glass, cans, bottles, etc.) extends the useful life of the fruit or fruit products because the pears can be sterilized and distributed economically without microbial spoilage. The thermal processing also stops the ripening and senescence that typically limit the useful life of fresh pears. Unfortunately, the heat involved in thermal processing results in many changes to the physical characteristics of the pears.

The chlorophyll found in the skin of green pears will darken or brown when heated during thermal processing. The resultant olive color is much less aesthetically desirable than the bright green color of fresh pears. As a consequence, pears are normally pealed prior to thermal processing, leaving the familiar yellow to tan to white product associated with typical canned or bottled pears. Many chemical constituents are concentrated in the peel, so consuming the whole fruit is nutritionally more beneficial to the user than consumption of the peeled fruit. However, peeling prior to processing results in a pear with fewer nutrients. In the past, the trade off of canned convenience has justified this loss.

The use of zinc ions to form more stable green pigments that are not subject to discoloration has been known for many years. The information is common enough knowledge that is presented as common knowledge in food chemistry without citation. It has been used in food processing under certain special conditions to retain green color in certain thermally processed foods, particularly green vegetables, such as spinach, green beans, and peas. Food-grade zinc salts are allowed ingredients in the United States. However, this content must generally be declared as part of the ingredient list, and often discourages purchase of products containing it by consumers who are unaware of its generally harmless, and perhaps beneficial, effects.

The use of zinc in vegetables has been the subject of a number of U.S. patents. For example, U.S. Pat. No. 5,482,727 to LaBorde et al. teaches a method for improving the color of containerized green vegetables. U.S. Pat. No. 5,114,725 to Leake et al. teaches a method for color preservation in canned green vegetables. In a variation on this theme U.S. Pat. No. 4,840,808 to Lee et al. teaches the use of zinc to stabilize chlorophyll used to color pasta. Similarly, U.S. Pat. No. 4,615,924, U.S. Pat. No. 4,478,860, and U.S. Pat. No. 4,473,591 teach other specific approaches to use zinc for color retention in vegetables.

None of these patents disclose or suggest use of zinc to stabilizing the color of fruit, much less green pears in particular. Likewise, none of these patents envisions treatment of whole fruit to restrict the uptake of zinc into the fruit. Furthermore, none of these patents teach the use of zinc treatment to enhance the aesthetics and nutrition of peel on pears or other green fruit.

Thermal processes of green fruits and vegetables often cause a significant loss of chlorophylls in the products, hence a shift of an attractive green color to yellow or olive color. The chemical basis for the loss of green pigments upon thermal processing has been extensively studied (Elbe and Schwartz, 1996). In general it is associated with a reduction in the amount of chlorophylls present in the plant material. Elbe and Schwartz (1996) reported that blanching and commercial heat sterilization can reduce chlorophyll content by as much as 80 to 100%. They also showed that chlorophyll degradation during heating is a sequential and irreversible process in aqueous solution (Elbe and Schwartz, 1996). Initially, the magnesium atom in the chlorophyll is displaced by hydrogen ions, resulting in pheophytins. Prolonged heating in commercial sterilization leads subsequent decarbomethoxylation of pheophytin to form pyropheophytins (LaBorde and Elbe, 1994a; Elbe and Schwartz, 1996; Weemaes et al, 1999).

Efforts to preserve green pigment in processed green fruits and vegetables have concentrated on retaining chlorophylls, forming or retaining green derivatives of chlorophyll, such as chlorophyllides, or formatting new metallo complexes (Elbe and Schwartz, 1996). Approaches, such as high temperature and short time processing, addition of alkalizing agents, blanching at low temperature, and enzymatic conversion of chlorophylls to chlorophyllides have been proposed. These methods can only retain green color immediately after treatment or within a short storage time, and products are very unstable during long period of storage (LaBorde and Elbe, 1994a; Elbe and Schwartz, 1996). Moreover, some treatments result in tissue softening and flavor change of the product (Elbe and Schwartz, 1996).

Formation of complexes between bivalent metal ions of Zn²⁺ or Cu²⁺ and the Mg-free chlorophyll derivatives, such as pheophytin or pyropheophytins, has resulted in preservation of green pigments (Elbe and Schwartz, 1996; Leak and al, 1992; Theuer and Richard, 2001). The two hydrogen atoms within the tetrapyrrole nucleus of pheophytins are easily displaced by zinc or copper ions. Further heating increases the zinc pyropheophytin concentration at the expense of a decrease in zinc pheophytin (Elbe and Schwartz, 1996). Zinc or copper pheophytin and pyropheophytin complexes have very similar color to that of chlorophylls (Elbe and Schwartz, 1996; Tonucci and, Elbe, 1992). In addition, they are much more thermal resistant and stable in low pH solution compared to chlorophylls (Elbe and Schwartz, 1996).

Further studies have indicated that the formation of the metallo chlorophyll derivative complexes depend on Zn concentration, chlorophyll concentration, and pH value. In spinach purees, zinc complex formation does not occur in puree containing less than 25 ppm Zn²⁺ (Elbe and Schwartz, 1996). With regard to chlorophyll content, spinach puree that contains 12 times higher chlorophyll concentration than that of pea puree retains approximately 40 times more zinc complex than that of pea puree after heated at 121° C. for 60 min with 75 ppm Zn²⁺ ion addition (LaBorde and Elbe, 1990). With respect to pH, zinc complex formation increases in purees with a pH between 4.0 and 6.0, but decreases at pH values of 8.0 or greater (LaBorde and Elbe, 1994a and b).

Metallo-chlorophyll complexes have potential application in the food industry to yield desirable green color of fruits and vegetables. A patent was issued that describes a process that includes blanching of vegetables in an aqueous ZnCl₂ solution followed by thermal treatments (LaBorde et al., 1996). Another patent describes color improvement of green vegetables through the addition of an aqueous packing solution containing zinc or copper ions (Leake et al., 1992). In spite of the numerous approaches using zinc salts to provide an improved green color to processed vegetables, commercial production of containerized and thermally sterilized green vegetables having a green color has not been successful (Theuer and Richard, 2001). One of the major reasons for this failure is that the amount of zinc required to yield a satisfactory color exceeds the FDA limit of 75 ppm.

Thus, there exists a need in the art for processes and compositions for producing color-stabilized fruits and vegetables that are not only aesthetically pleasing, but that have long-lasting color stabilization, that have colors that are identical or very similar to the natural color, that are suitable for governmental approval, and that are appealing to consumers, both from a visual and cost perspective.

### SUMMARY AND DESCRIPTION OF THE INVENTION

The present invention addresses needs in the art by providing processing procedures for green fruits and vegetables that result in full or partial retention of the naturally-occurring green color. The processes are particularly well suited for thermally processed vegetables and fruits, such as green pears. The processes permit processing of vegetables and fruits, such as pears, without the need to first peel the vegetable or fruit, an aspect that not only reduces the cost and time of processing, but also permits packaging of a product that more closely resembles a fresh product. For example, it permits packaging of a peels-on green pear, which has superior nutritional value as compared to peels-off pears. Using the present invention, a thermally processed vegetable or fruit, such as a peels-on pear, showing natural pigments or near natural pigments on the peel or skin can be obtained. Such a product is not only commercially appealing to consumers, but can be less expensive for manufacturers to produce.

To maximize the desirability of color-stabilized green vegetables and fruits, a solution was needed that did not require the addition of food additives or colorants. Although one can easily envision adding artificial or natural colors to achieve the desired color, a more desirable product would rely on the natural color in the skin. A more desirable product would likewise contain the original flesh of the vegetable or fruit, and would avoid pale or yellow flesh or fruit that is commonly available today. Recognizing these desirable characteristics, a process, and resulting products, were invented.

Thus, in a first aspect, the present invention provides a method or process (used interchangeably herein) for retaining the green coloration of a vegetable or fruit. The process comprises one or more of the following steps: 1) treating the vegetable or fruit with an antioxidant; 2) performing a zinc vacuum infusion; 3) performing a zinc diffusion; and 4) performing a zinc hot fill. The method may also comprise an initial color sorting step to identify and cull all vegetables having similar green coloring. The method may additionally comprise packaging the vegetable or fruit. Furthermore, the method can further comprise thermal processing of the vegetable or fruit, which is preferably performed in conjunction with a packaging step, and is preferably performed after the packaging.

Color sorting can be performed to identify vegetables and fruits that are of like green color to enable the practitioner to grade the ultimate product, and to ensure that a product containing little variation in color is produced. It has been found that the present process is most suitable for vegetables and fruits having a minimum level of green color. The minimum level can be determined using any suitable method, including visual inspection or inspection of fruit or vegetable skin or peel using photometric equipment. For example, it can be rapidly and reasonably accurately approximated by visual inspection of the color of the vegetable or fruit. Generally, the color level is related to the amount of chlorophyll present, chlorophyll typically being responsible for the vast majority of the green color of vegetables and fruits. Although the present invention is advantageously practiced on green vegetables and fruits that have a relatively high content of chlorophyll and/or other green pigments, it can be successfully practiced with a wide variety of vegetables and fruits having relatively little green color as well. However, it is to be expected that the color of the vegetable or fruit at the beginning of the process will affect the ultimate green coloring of the vegetable or fruit at the end of the process.

The method of the invention can comprise treating the vegetable or fruit with an antioxidant. Treating can be any action that permits contact of the antioxidant with chlorophyll or other green pigment in the vegetable or fruit. Thus, it can include simply exposing the vegetable or fruit to the antioxidant for a sufficient amount of time to permit contact of the antioxidant and a green pigment. The antioxidant can be any antioxidant known in the chemical or food processing arts. Thus, it can be any anti-oxidizing or reducing organic or inorganic acid. Likewise, it can be any biologically relevant anti-oxidant. Thus, examples of antioxidants that can be used in the present invention include, but are not limited to, ascorbic acid (vitamin C), α-tocopherol (vitamin E), folate, β-carotene, ubiquinone (coenzyme Q10), bioflavonoids, and selenium. The antioxidant can be provided as a liquid solution or as a solid (e.g., a dried powder). The antioxidant is provided in a sufficient amount to stabilize a sufficient amount of chlorophyll in the vegetable or fruit to retain substantially all of the green color of the vegetable or fruit through the process of the invention. Specific amounts will vary depending on the vegetable or fruit, level of chlorophyll, and volume of vegetable or fruit being processed. Likewise, the amount will depend, at least to some extent, on the amount of time the vegetable or fruit is exposed to the antioxidant. The amounts of antioxidant and time of exposure can be determined by those of skill in the art without undue or excessive experimentation.

In embodiments, the method comprises performing a zinc vacuum infusion. That is, the method comprises infusing the vegetable or fruit, or a portion thereof, with zinc using vacuum assistance. This step is useful in increasing the retention of green color in the treated material. The vacuum pressure applied can be any suitable pressure, which can be selected by the practitioner based on standard conditions known in the art for treating vegetables and fruits with other substances, and in view of the teachings below. Likewise, the temperature used at this stage in the processing can be any suitable temperature, as selected by the practitioner based on temperatures known to be suitable for processing of vegetables and fruits.

The process of the invention can also comprise performing a zinc diffusion step. That is, the method comprises infusing the vegetable or fruit, or a portion thereof, with zinc by simple diffusion of the zinc into the fruit or portion thereof. As with the vacuum infusion, this step is useful in increasing the retention of green color in the treated material. The diffusing of zinc into the vegetable or fruit can be performed at any suitable temperature and time. Suitable temperatures and times for treating vegetables and fruits during processing are known to those of skill in the art, and thus need not be detailed here.

The method can further comprise performing a zinc hot fill. A zinc hot fill is a step of treating the vegetable or fruit, or portion thereof, prior to packaging with a solution containing zinc. This solution may be left in contact with the vegetable or fruit during packaging, and thus may be a part of the final packaged product. Suitable amounts of zinc to be used in this step are any amounts that stabilize, at least to some extent, the green color of a vegetable or fruit prior to, during, or after packaging. From a practical standpoint, upper limits of the amounts will be defined by governmental health and safety agencies, such as the Food and Drug Administration (FDA). As with other steps, the temperature during this step may be set and adjusted to achieve a desired amount of stabilization of green color.

Other steps may be included in the process of the invention, and can be performed before or after one or more of the steps discussed above. For example, the process may further comprise cleaning the vegetable or fruit, cutting the vegetable or fruit into pieces or portions of desired size or shape, and/or adding one or more substances to the vegetable or fruit, such as flavorings, sugars, other vegetables or fruits, meat, etc. In addition, the process can be practiced on two or more different vegetables and/or fruits simultaneously.

In certain embodiments, the process further comprises packaging the vegetable or fruit. Packaging can be accomplished by any suitable means known and/or practiced in the food packaging industry. Such processes are well known and widely practiced, and thus need not be detailed here.

Furthermore, the method can further comprise thermal processing of the vegetable or fruit, which can result in a sterilized or sterile product or a product with a long shelf-life. Thermal processing of vegetables and fruits is a well known and widely practiced activity. Any suitable thermal processing procedure known and/or practiced in the art can be used in accordance with the invention.

### BRIEF DESCRIPTION OF THE FIGURES

FIG. 1 shows a flow diagram for processing of vegetables or fruits according to various embodiments of the invention.

FIG. 2 shows a flow diagram for processing of green pears according to one embodiment of the invention.

### DETAILED DESCRIPTION OF EXEMPLARY EMBODIMENTS

The invention will now be described with reference to certain specific embodiments and features, which are provided to more fully describe certain aspects of the invention. The following description is not intended to fully describe all embodiments of the invention.

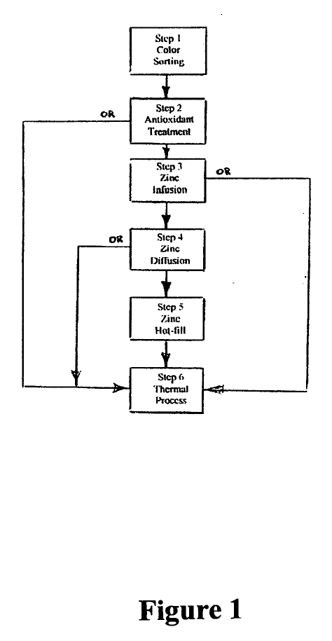

The present invention provides a food grade process for thermally sterilizing packaged vegetables and fruits. The process, as practiced in preferred embodiments, is generally depicted in FIG. 1, in which optional steps can be performed or omitted. In embodiments, the exemplary fruit is pears. In these embodiments, the process allows the retention of green color in peel-on thermally processed pear products by using certain specific process conditions and zinc. This process improves both the appearance and nutritional value of the processed pears. This same process can be applied to other fruit where green color stabilization is desired.

In embodiments, this invention teaches bringing zinc ions into contact with the chlorophyll of the pear skin where a thermally activated substitution of zinc for the magnesium of chlorophyll yields the color desired, and a stabilized green pigment that will endure thermal processing to yield a skin having a desirable color upon thermal processing. Increasing the permeability of the peel by removing an outer layer, through washing or brushing or the like, permits improved contact between the zinc and chlorophyll. Similarly, this same concept can be applied to other fruit and vegetables. The contact between the zinc ions and the chlorophyll in the most preferred embodiment requires removal of the wax or cuticle layer of the vegetable or fruit (e.g., pear), as discussed in greater detail below.

Numerous embodiments of the current invention have been tested and evaluated, and provide various benefits. Different benefits can be obtained by practice of the various embodiments of the invention. The work specifically discussed below has shown benefits with green pears in general and specifically with the three common green varieties, Bartlett, D'Anjou, and Cornice.

While any soluble form of zinc is expected to yield the color stabilization reaction, the particular teachings of the disclosed embodiments of this invention focus on the use of zinc lactate, which was found to be both soluble and readily available. Zinc lactate does not impart a salty taste to the fruit. Zinc chloride does impart a salty taste. Therefore, one may chose among these two depending on the desired taste to be imparted, among other things.

The use of zinc has been tested at various concentrations, such as at 0.5%, 1%, and 2% (w/v) with whole pears and chunks at various stages in processing, including pre-soaking, blanching, hot filling, and canning to evaluate the degree to which color stabilization occurs. Pre-soaking with vacuum infusion was also specifically evaluated. In these studies, various degrees of color stabilization were obtained, and thus various parameters may be adjusted to achieve desired results. Thus, certain embodiments may have some benefits that others do not.

Washing and brushing to remove the wax layer and increases the permeability of pear peels to the metal ions was shown to be beneficial, and provided improved benefits of zinc treatment. These benefits were also enhanced when vitamin C was used as an antioxidant and to prevent browning during treatment. It appears that retained oxygen in the fruit and peel might promote browning reactions, and that brushing and/or vitamin C treatment reduced this tendency. Brushing can be done with a variety of abrasive materials including, but not limited to, sand-paper, cleaning cloths or sponges, or knives. In certain embodiments, knives where found to be highly effective in removing the wax and cuticle layers of pears without removing the peel or damaging the green chlorophyll tissue underneath. Knife treatment with vitamin C was used in all of the examples described below. In addition, vitamin C was used at 1%.

### EXAMPLES

The following Examples are provided to describe certain embodiments of the invention. The Examples are not meant to be limiting in any way of the invention.

### Example 1

### Treatment of Pears with Pre-Soaking and Thermal Treatment

Pears were treated by pre-soaking followed by thermal processing, and the resulting effects on skin color were observed. It was found that increasing color retention was obtained with pre-soaking and thermal treatment in zinc lactate solutions after wax removal. Pre-soaking in 1% zinc lactate for 120 to 150 minutes prior to canning produced greener pears than no treatment. Additional improvement in color retention was obtained by adding 1% zinc lactate to the canning solution itself (i.e., performing hot fill) Some comparative results are tabulated in Table 1.

TABLE 1
Observations on the color of canned Comice pears tested with
different zinc lactate concentration in pre-soaking and canning
solutions. Pre-soaking was 120 minutes in all cases.

| Zinc lactate in | Zinc lactate in canning | Degree of |
|---|---|---|
| pre-soak (%) | solution (%) | green color |
| 1 | 1 | Very Green |
| 1 | 0.5 | Green |
| 1 | 0.1 | Bleached/yellow |
| 1 | 0 | Bleached/yellow |

One concern in using zinc ions in a canning solution is the potentially high zinc content in the final products. According to FDA regulations, a maximum of 75 ppm zinc ions is allowed in final products. The pre-soaking step may result in final products having zinc concentrations above the FDA limit. Therefore, the amount of zinc should be maintained at a low level, and this step might be suitable only for limited applications.

### Example 2

### Determination of Exemplary Zinc Concentrations

A second set of examples illustrates the benefits of meeting a minimum zinc lactate concentration and the benefits of blanching in the process of treating according to the invention. This set of examples also demonstrated that additional pH control was not necessary in certain embodiments. Starting with D'Anjou pears without wax and treated with 1% vitamin C, increasing concentrations of zinc lactate in the blanching solution were tested. To reduce the subjective nature of the color assessments, Hunter color values for hue were used. Values around 100 correspond to bright green. Blanching time was held to 13 minutes for all experiments, and the results are tabulated in Table 2.

TABLE 2
Hunter color hue values of D'Anjou pears blanched in
various concentrations of zinc lactate for 13 minutes at
94 degrees C. prior to canning in water for 20 min.

| Zinc lactate concentration (%) | Hunter hue |
|---|---|
| 1 | 99.7 |
| 0.5 | 101.3 |
| 0.2 | 96.7 |
| 0.1 | 94.3 |

These examples illustrate the advantage of using a minimum of 0.5% zinc, and that exceeding 1% does not provide any apparent advantage. Acidifying the blanch water with 0.18% citric acid was found not to provide any particular advantage, and is thus not preferred.

### Example 3

### Determination of Suitable Blanching Time

In view of the results above that blanching is an effective means for retaining color in pears, various blanching times were tested. As can be seen in Table 3, advantages of blanching can be obtained in a short amount of time, and increasing that time does not appear to provided any significant enhancement of color retention of Bartlett pears. a minimum amount of time can be identified time to 20 minutes was not found to significantly enhance the color of Bartlett pears.

TABLE 3
Hunter color hue values for Bartlett pear chunks blanched
in 1% zinc lactate solutions at 96 degrees C. for various
times and then canned in water for 20 min.

| Blanching time (minutes) | Hunter hue |
|---|---|
| 13 | 100.8 |
| 16 | 100.8 |
| 20 | 101.9 |

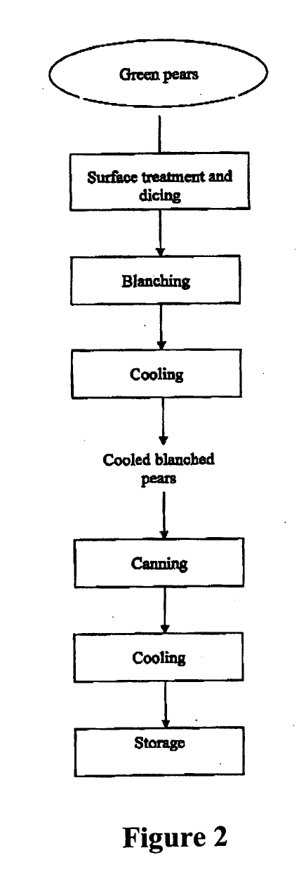

An embodiment of the invention thus is a process of preparing green pears having stabilized green color, where the method includes blanching of the pears during the process. A flow diagram of an embodiment of the invention that includes blanching is depicted in FIG. 2. In this embodiment, surface treatment and dicing comprises exposing the pears to 1% ascorbic acid, and removing the wax and cuticle of the pear skin with a knife or other suitable method. Blanching is performed in the presence of a 1% zinc lactate (equilibrium to 2150 ppm Zn²⁺) solution at 94° C.-98° C. for 12-14 minutes. Cooling is achieved by rinsing through water for about 30 minutes. Canning is performed using commercial canning processing conditions. The pears are heated in the cans or jars filled with water at 94° C. for 20 minutes.

### Example 4

### One Process According to the Invention

For making pear chunks, pears were first diced into 2×2×1.5 cm chunks in 1% ascorbic acid (Vitamin C) to prevent enzymatic browning. The peel surface of the chunks was then brushed with a stainless steel knife in the same ascorbic acid solution. Pear chunks were then blanched in hot zinc lactate solution. Zinc lactate solutions were prepared by dissolving zinc lactate in boiling distilled water. The first chunks were immersed in glass jars at a ratio of 1:2.5 (fruit to zinc solution; weight:weight). After the jars were sealed, they were heated for the selected blanching time to about 96° C. Blanched fruit was taken out of the jars and rinsed to remove excess zinc solution prior to canning in water. The final canning was 20 min at greater than 95° C.

### Example 5

### A Detailed Process According to the Invention

This Example provides details on various preferred embodiments for carrying out the process of the invention. It is particularly focused on processing of pears.

Materials and Methods: Three varieties of green pears (Pyrus communes, L. Rosaceae), Bartlett, D'Anjou, and Cornice were used in this study. Fruits were provided by Diamond Fruit Growers, Inc. (Odell, Oreg.). Zinc ions were from zinc lactate dehydrated salt (PURAMEX ZN, PURAC America, Lincolnshire, Ill.). Vitamin C (99.8%) was purchased from Mallinckrodt Baker, Inc (Paris, Ky.). Tween 20 from Aldrich Chemical Company (Milwaukee, Wis.), and Ajax dishwashing detergent were used as surfactants. Anhydrous citric acid was purchased from Integra Chemical Company (Renton, Wash.).

Sample Preparation: Whole pears or pear chunks were used in this study. To make chunks, the fruits were first cut in half lengthwise, and then carefully cut crosswise into thick slices. Fruit slices were further immersed in 1% vitamin C solution to remove kernels and dice into chunks. In order to effectively retain green pigments on the peels, the zinc ions need to be able to contact chlorophylls in the peel tissues. Attempts to increase the permeability of the peels by removing the wax layer on pear surface through washing or brushing were tested. Washing was performed by rinsing pears under warm tap water (60-65° C.) followed by washing in Tween-20 solution or Ajax dishwashing detergent. Brushing was done by rubbing the fruit surface with sand-paper, cleaning sponges, or knives.

Zinc treatment: One of the goals of this study was to identify optimal processing conditions and procedures to retain green pigment during thermal processing by infusing zinc ions into the peels of pears, while still following FDA regulation of 75 ppm zinc in processed foods. Zinc application was tested under various concentrations of zinc lactate (0.5%, 1%, and 2%) and treatment time at different stages of canning process, including pre-soaking, blanching, hot filling, and canning to evaluate the best color retention. In addition, pre-soaking was evaluated at atmospheric pressure and under vacuum. For vacuum pre-soaking treatment (or called vacuum impregnation, VI), samples were immersed in zinc lactate solution contained in a jar that was placed inside a sealed chamber subjected to 100 mmHg vacuum for 20 min using a vacuum pump (Model 0211 P204, Gast MFG. Corporation, Benton Harbor, Mich.). After vacuum, the fruit jar was taken out of the chamber and let stand in room conditions for 40 min. For atmospheric pressure pre-soaking, fruits were immersed in zinc lactate solution for 60 min. The effects of the pH of blanching or canning solutions on the color of canned products were also studied. The pH of the solutions was adjusted by using citric acid (0.18%, weight based).

Color Measurement: Objective color measurement on the peels of the pears was conducted using a Hunter Lab spectrometer (Lab Scan 11, Hunter Associates Laboratory, Reston, Va.). The instrument was calibrated against a standard white reference tile (X=78-25; Y=82,85; Z=85.83). A fruit chunk with its peel facing the light beam was placed on the opening of the sample port above the light source, and covered with a black box. Color values were recorded in terms of tristimilus color values of L*, a*, and b*. C* (Chroma) and h* (hue) values were calculated as:
C*=sqrt[(a*)²⁺ (b*)²]
h*=arctan(b*/a*)

Shelf-life Study: Canned peels-on pears were subjected to a shelf-life study. Six pear chunks from Bartlett pears were packed in glass jars and stored at temperatures of 10, 21, and 38° C. under florescent light up to 6 months. An accelerated shelf-life study was conducted. Color and pH of the samples were analyzed every 4 weeks.

Pre-treatment Study: This study demonstrates that pretreatment by brushing off the surface wax layer and a part of the cuticle layer on the peels of pears is beneficial to retain green pigments during thermal processing using zinc ions. In this experiment, pears were pre-soaked in 2% zinc lactate solution with or without surface brushing treatment before thermal processing. The pears without surface brushing had a brown color after canning, while the other two pears (brushed by knives) retained some green pigments. Brushing by use of knives had removed the wax layer and a part of the cuticle layer on the pear peels. It is believed that these outer layers not only block zinc ions from entering into and locating on the peel tissues, but also limit oxygen escape from the pores of the fruits. With plenty of oxygen presence under the peels, oxidation reactions were favored during thermal treatment and caused browning discoloration on the pear peels. In contrast, a pear having been brushed had an attractive green color after canning. This confirmed an effective diffusion of zinc ions into the peel once its surface was brushed.

Besides using a knife, other alternative means of brushing were tested. Using sponges or sandpaper, we were able to take off the wax and cuticle layers, but these often caused the entire peels to come off. Use of knives was found to be most effective in this situation, both for removing the impermeable covering layer and limiting damage of green chlorophyll tissue underneath. Of course, other methods known in the art for cleaning vegetable and fruit skins will be suitable. Washing the pear surface with a surfactant or detergent (Tween 20, Ajax dishwashing detergent) also yielded brown canned pears (results not shown).

### Example 6

### Pre-Soaking and Thermal Treatment in Zinc Solution

Table 4 shows the Hunter color values of canned pears (organic d'Anjou) subjected to pre-soaking treatment in 1% zinc lactate solution for different time periods. Canned d'Anjou pears that were pre-soaked in 1% zinc lactate solution had hue values of higher than 90 degree, suggesting the retention of green pigments. The sample pre-soaked for 150 minutes in zinc lactate solution had a hue value of 96.67, resulting in a yellow color that contains some greenness, fairly close to that of the fresh pear (99.97). The sample with shorter pre-soaking time (60 min) had a lower hue (93.91), showing less greenness. Hence, this experiment indicates that, for some fruits, such as pears, the longer the pre-soaking time is, the greener the canned products are.

TABLE 4
Hunter color values fo fresh pears (organic green d'Anjou)
and their canned products that were pre-soaked in 1% zinc
lactate solution for 60 minutes at atmospheric pressure,
then canned in water at 94° C. for 20 minutes.

| Sample | Pre-soak | | | | | |
|---|---|---|---|---|---|---|
| No. | time (min) | L* | A* | b* | Hue | Chroma |
| 1 | 0 | 59.03 | −7.100 | 40.38 | 99.97 | 41.00 |
| 2 | 60 | 47.97 | −2.465 | 36.03 | 93.91 | 36.11 |
| 3 | 150 | 52.79 | −4.17 | 35.54 | 96.69 | 35.78 |

Results in Table 5 show that pre-soaking in a zinc lactate solution yielded a sample with a higher hue value (92.24) than that of a sample not having been pre-soaked (89.12). Although at this hue value, both samples were still yellow, the one that was pre-soaked in zinc solution retained some green color. This confirms that pre-soaking in a zinc solution can contribute to the retention of green pigment during thermal processing of green pears.

TABLE 5
Hunter color values of canned pears (green d'Anjou) pre-soaked
in 1% zinc lactate at atmospheric pressure and canned in water
at 94° C. for 20 minutes vs. samples without pre-soaking

| Treatment | L* | a* | b* | Hue | Chroma |
|---|---|---|---|---|---|
| 120 min pre-soak | 44.84 | −1.55 | 39.55 | 92.24 | 39.58 |
| No pre-soak | 43.57 | 0.47 | 30.65 | 89.12 | 30.65 |

Adding zinc ions in the canning solution was found to be more effective in retaining green pigments on pear peels than that in pre-soaking solutions. Comice pears pre-soaked in zinc lactate solution and then thermally treated in a 0.5% or 1% zinc lactate solution had a bright green color (see Table 1, above). Meanwhile, the samples pre-soaked in zinc lactate solution and canned in water containing no or low concentrations of zinc lactate (0.1%) had a yellow color. Thus, adding zinc ions in canning solutions is effective to retain green pigments. The effectiveness of zinc treatment appears to depend on the concentration of zinc ions and the permeability of the pears. While not being limited to any particular theory, compared to that of fresh pears, the permeability of thermally processed pear tissues appears to be highly improved due to heat effects, which in turn favors the zinc ion's entry in contacting and reacting with chlorophyll derivatives. As discussed above, a concern in using zinc is the amount present in the final product. We have found that an effective way to keep the final concentration of zinc in the product down is to take advantage of the high temperature to enhance the infusion of zinc ions into the peels, while using a water rinse afterward to remove excess zinc. Additionally, although it may be used, pre-soaking in zinc lactate appears to provide little advantage. Thus, it may be omitted.

### Example 7

### Zinc Concentration and Thermal Treatment Steps

The color of canned pear chunks (organic d'Anjou) blanched in a zinc lactate solution and canned in water can be dependent on the concentration of zinc lactate. Table 6 shows that the hue value of canned pear chunks (organic d'Anjou) increased along with increased zinc concentration in the blanching solution. This study found that concentrations at or above 0.5% were better than those below 0.5%, and thus 0.5% may be the minimum preferred concentration of zinc lactate to be use in blanching solutions to yield green chromophores on organic d'Anjou pears. However, due to differences in fruit texture, amount of chlorophyll on the peels, age of the fruit, maturity of the fruit, and variety of the fruit. Using a very high zinc ion concentration may enhance green color of canned pears, but it might increase the amount of zinc ions absorbed into the pears to a level that exceeds FDA regulations. A zinc lactate level of 1% may be an appropriate and economical compromise to take into account the difference in maturity and variety and in limiting zinc ion absorption, as well as assuring uniform color from batch to batch.

TABLE 6
Hunter color values of organic d'Anjou green pears that were blanched
in 0.1, 0.2, or 0.5% zinc lactate (ZnL) solution at 94° C. for
13 min then canned in water at 94° C. for 20 minutes.

| ZnL concentration | | | | | |
|---|---|---|---|---|---|
| in blanching | | | | | |
| solution (%) | L* | a* | b* | Hue | Chroma |
| 0.5 | 46.7 | −6.0 | 30.2 | 101.3 | 30.7 |
| 0.2 | 48.6 | −4.2 | 36.0 | 96.7 | 36.3 |
| 0.1 | 46.6 | −2.2 | 29.9 | 94.3 | 30.0 |

Zn²⁺ green complexes are formed in both blanching and canning processes, yielding a final product with an attractive bright green color. Results presented in Table 7 show that the color of green d'Anjou pears blanched at 94° C. for 13 minutes in 0.5% or 1% zinc lactate solutions had a hue value of 95.4 (yellow) and 93.2 (yellow green), respectively. When blanched products were subsequently canned in water, their hue values increased to 101.2 and 99.7, respectively (these numbers representing bright green color). While not conclusive, these data suggest that the reactions forming green chromophores started in the blanching step and continued to take place during the canning process, even though no more zinc was added in the canning solution.

TABLE 7
Hunter color values of d'Anjou green pear chunks blanched
in 0.5% or 1% zinc lactate (ZnL) solutions at 94° C. for
13 min and then canned in water at 94° C. for 20 min

| Thermal Treatment | L* | a* | b* | Hue | Chroma |
|---|---|---|---|---|---|
| Blanching in 0.5% ZnL | 52.3 | −3.0 | 31.9 | 95.4 | 32.1 |
| Blanching in 0.5% ZnL | 46.6 | −6.1 | 30.8 | 101.2 | 31.4 |
| Canning in Water | | | | | |
| Blanching in 1% ZnL | 49.4 | −1.7 | 29.9 | 93.2 | 30.0 |
| Blanching in 1% ZnL | 49.0 | −5.3 | 31.2 | 99.7 | 31.6 |
| Canning in Water | | | | | |

In order to determine whether processed peaches meet the 75 ppm FDA limit for zinc content, and how to achieve that limit, analysis of zinc ions was conducted for canned pears processed by blanching in zinc lactate solutions then cooled with the products still immersed in the blanching solution to room temperature before canning. The zinc quantity in the final products produced in this way was found to be as high as double the allowed level. To reduce the zinc content in the canned pears, the process was revised in a way that limits the contact time of pears with the zinc lactate solution by directly transferring hot blanched pears from the blanching solution to the canning solution, skipping the cooling step after blanching. Another alternative used was to cool the hot blanched pears in water, instead of in the zinc solution.

### Example 8

### pH Adjustment of Canning Solutions

Table 8 shows that adding acid in the canning solution after blanching pears in a zinc solution resulted in green canned pears. However, adding acid in the blanching solution yielded a yellow canned product. Thus, it is unnecessary to reduce the pH value of the blanching solution. On the other hand, the pH of the canning solution may be formulated with acids without any loss of newly formed green chromophores.

TABLE 8
Observations on the color of canned pears blanched in a 1%
zinc lactate solution with or without the use of citric acid,
and then canned in water with or without added acid

| | | Color of |
|---|---|---|
| Blanching Solution | Canning Solution | Canned Product |
| 1% ZnL (pH 6.0) | Water and 0.18% citric | Green |
| | acid (pH 3.5) | |
| 1% ZnL and 0.18% citric | Water | Yellow |
| acid (pH 3.6) | | |

### Example 9

### Blanching Time

In a more detailed study as a follow-on to Example 3, this study found that a blanching time period of 13 minutes or over would yield the desired green color on green pears (as was found in Example 3). Table 9 shows that hue values of canned pear chunks previously blanched in 1% zinc lactate solution for 13, 16, or 20 minutes are not significantly different. Hue values over 100 degrees represent bright green color. However, blanching less than 10 minutes resulted in canned pears with a yellow color (results not shown). The blanching time also can be adjusted based on the variety and maturity of pears. As demonstrated in this study, a blanching time of 13 minutes is typically adequate to yield an attractive and uniform green color of canned pears of Cornice, d'Anjou, and Bartlett.

TABLE 9
Hunter color values of Bartlett pear chunks blanched in 1% zinc
lactate solution at 94°-98° C. for selected time periods
and then canned in water at 94° C. for 20 minutes

| Blanching Time (min) | L* | a* | b* | Hue | Chroma |
|---|---|---|---|---|---|
| 13 | 50.14 | −7.88 | 41.21 | 100.83 | 41.96 |
| 16 | 44.54 | −6.19 | 32.48 | 100.79 | 33.06 |
| 20 | 50.96 | −8.26 | 39.02 | 101.95 | 39.88 |

### Example 10

### Final Processing Scheme for Retaining Green Pigments on Green Pears

This study has led to the development of a process of retaining green pigments on green pears, which is depicted in FIG. 2. In this study, for making pear chunks, pears were first diced into 2×2×1.5 cm³ blocks. This was performed in a 1% ascorbic acid solution to prevent immediate and enzymatic browning. The surfaces of the chunks were then brushed with stainless steel knives in the same ascorbic acid solution. Pear chunks were then blanched in hot zinc lactate solutions as follows. Zinc solutions were prepared by dissolving zinc lactate in boiling distilled water in glass jars. The fruit chunks were immersed in the glass jars at a ratio of 1:2.5 (fruit to zinc solution; weight:volume). After the jars were sealed, they were put inside a sterilizer (Model 25×, All American, Manitowoc, Wis.) for a selected blanching time of 13, 16, and 20 minutes. The 20-liter sterilizer contained about 13 liters of water and had a heater coil at the bottom to maintain water temperature at about 94-98° C. during the treatment. A mercury thermometer was used to read water temperature inside the sterilizer. Afer blanching, the jars were cooled under tap water to room temperature. Blanched fruits were then taken out of the jars, briefly washed with distilled water, again filled into boiling water in 235 ml glass jars (Alltrista Corp., Muncie, Ind.) (1 fruit: 1 water, volume based). The jars were sealed and sterilized at 95° C. for 20 minutes in a Precision water bath (Precision, Winchester, Va.). After the sterilization, jars were immediately cooled under tap water. Subsequent color observations with eyes and by use of a spectrometer were conducted for the peels of the pears, as discussed above.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

1. A product comprising a green vegetable or fruit having its color stabilized with zinc.

2. The product of claim 1, which is a fruit.

3. The product of claim 1, which is a thermally stabilized product.

4. The product of claim 1, wherein the product is a whole pear or a portion thereof.

5. The product of claim 1, comprising 75 ppm or less of zinc.

6. A process for stabilizing the color of a green vegetable or fruit, said process comprising exposing the vegetable or fruit to zinc.

7. The process of claim 6, wherein the zinc is in the form of zinc lactate or zinc chloride.

8. The process of claim 6, further comprising pre-soaking, blanching, canning, or any combination of two or three of these, the vegetable or fruit.

9. The process of claim 6, wherein said zinc is exposed to said vegetable or fruit at a concentration of about 0.25% to about 1% zinc lactate.

10. The process of claim 9, wherein said zinc lactate concentration is about 0.5%.

11. The process of claim 6, wherein said exposing is for about 13 minutes or more.

12. The process of claim 11, wherein said exposing is for about 13 minutes to about 20 minutes.

13. The process of claim 6, wherein said exposing is performed, at least in part, at a temperature of between 94° C. and 98° C.

14. The process of claim 13, wherein the temperature is about 96° C.

15. The process of claim 6, wherein the fruit is a pear or portion of a pear.

16. The process of claim 15, wherein the pear is a D'Anjou, Comice, or Bartlett.

17. A container comprising a thermally processed green fruit or vegetable, wherein the fruit or vegetable was processed in the presence of zinc, and wherein the fruit or vegetable retains substantially all of its original green color.

18. The container of claim 17, wherein the container contains a fruit.

19. The container of claim 18, wherein the fruit is a pear.

20. The container of claim 18, wherein the pear is a Bartlett pear.

21. The process of claim 6, further comprising removing the outer layer of the vegetable or fruit.

22. The process of claim 21, wherein the outer layer is removed by washing or brushing.

23. The process of claim 21, wherein the outer layer is a wax layer or cuticle layer.

24. The process of claim 21, wherein the brushing is performed with knives, sandpaper, cloths, or sponges.

25. The process of claim 21, wherein removal of the outer layer does not remove the peel or damage the green chlorophyll tissue underneath.

26. The process of claim 21, wherein the removing step removes a wax layer and part of a cuticle layer of the vegetable or fruit.
